(19) United States
(12) Patent Application Publication
(10) Pub. No.: US 2015/0051846 A1
(43) Pub. Date: Feb. 19, 2015

(54) BEARING LIFE DETERMINATION DEVICE

(71) Applicant: FANUC Corporation, Yamanashi (JP)

(72) Inventor: Michi MASUYA, Yamanashi (JP)

(21) Appl. No.: 14/457,572

(22) Filed: Aug. 12, 2014

(30) Foreign Application Priority Data
Aug. 16, 2013 (JP) 2013-169259

(51) Int. Cl. G01M 13/04

(52) U.S. Cl. CPC G01M 13/04
USPC 702/34

(57) ABSTRACT

A corrected rotation amount, based on conversion to a rotation amount at a reference rotational speed, is obtained by multiplying a command speed read in each period by a period time and a coefficient value corresponding to the rotational speed. An integrated corrected rotation amount is obtained by integrating the corrected rotation amount. If this integrated corrected rotation amount exceeds a life limit value, the life of a bearing is determined to be exhausted.

### BACKGROUND OF THE INVENTION

1. Field of the Invention

The present invention relates to a device for detecting and determining the life of bearings used in machine tools and various other machinery.

2. Description of the Related Art

In various machinery, such as machine tools and robots, bearings that support shafts rotated by motors or the like are subject to degradation such as wear. If the bearings are degraded, the operation accuracy of the machinery is reduced. In the case of a machine tool, its machining accuracy is reduced. Since those bearings which support rapidly rotating shafts are worked hard, in particular, they are quickly degraded and shortened in service life.

To overcome this problem, a troubleshooting method for a speed reducer with a built-in robot has been proposed in which the maintenance level of a bearing (speed reducer) is indicated. In order to check the wear state of the bearing to use it as a criterion for the maintenance of the bearing, according to this method, an amount of work corresponding to an integrated rotation amount of the bearing and the iron powder concentration of grease for the bearing are previously stored in association with each other, and the iron powder concentration of the grease is measured. A similar technique is disclosed in Japanese Patent Application Laid-Open No. 2009-226488.

Further, a spindle state detector has been proposed as a measure for determining the life of a bearing for the spindle of a machine tool. Since the bearing life varies depending on the number of revolutions, or rotational speed, of the spindle and load on the bearing, according to this detector, the spindle speed is previously divided into a plurality of ranges. A normal life limit or lifetime is set in advance for each of a plurality of divided load ranges in each of the divided rotational speed ranges. Radial and axial displacement sensors are mounted on a bearing unit and used to measure radial and axial displacements, respectively. A load is calculated based on the measured displacements, and moreover, the spindle speed is detected using a speed sensor. Operating hours in a range including the calculated load and the detected rotational speed are integrated, and a current duty cycle for each range is calculated by dividing the resulting integrated operating time by the normal life limit or lifetime. The current duty cycle of the spindle is obtained by adding up the current duty cycles for the individual ranges, and the bearing life is determined by the obtained current duty cycle. Furthermore, the normal life limit or lifetime is preset for each range of a load factor, the load factor is obtained from the detected load and spindle speed and an allowable load for the load and speed, and the operating time for each load range including the load factor is obtained. In addition, the current duty factor for each load range is calculated by dividing the obtained operating time by the normal lifetime. Thus, the current duty factor of the bearing can be obtained by adding up the current duty factors for all the load ranges and used to determine the life of the spindle bearing. A similar technique is disclosed in Japanese Patent Application Laid-Open No. 2012-92910.

If the bearing life is simply determined by a total rotation amount associated with the iron powder concentration, the total rotation amount and the bearing life are inevitably estranged from each other. According to the technique disclosed in Japanese Patent Application Laid-Open No. 2012-92910, moreover, each low-speed revolution, or at low temperature, and each high-speed revolution, or at high temperature, differently influence the bearing life due to the difference in temperature. To overcome this, the normal lifetime is set in advance for each range of the spindle speed, and the life is determined in consideration of a temperature factor. However, this technique requires use of additional devices, such as the displacement and speed sensors, which must be installed near the bearing. These sensors require an additional space, thus resulting in an increase in cost.

### SUMMARY OF THE INVENTION

Accordingly, an object of the present invention is to provide a bearing life determination device capable of maintaining a bearing at a time closer to the actual life limit of the bearing in consideration of a temperature factor. Another object of the present invention is to provide a bearing life determination device obviating the necessity of a special device, such as a sensor, mounted on a bearing.

A bearing life determination device according to the present invention serves to determine the life of a bearing, which supports a rotation axis of a machine, and comprises a storage unit stored with data for a coefficient corresponding to a rotational speed of the rotation axis or a calculation formula for calculating the coefficient from the rotational speed of the rotation axis, a rotational speed detecting unit configured to detect the rotational speed of the rotation axis at a predetermined time interval, a rotation amount calculating unit configured to calculate a rotation amount of the rotation axis based on the detected rotational speed and the time interval, a corrected rotation amount calculating unit configured to obtain the coefficient corresponding to the rotational speed of the rotation axis detected by the rotational speed detecting unit, based on the data or the calculation formula stored in the storage unit and calculate a corrected rotation amount for life determination by multiplying the rotation amount calculated by the rotation amount calculating unit by the obtained coefficient, a corrected rotation amount integrating unit configured to integrate the calculated corrected rotation amount to obtain an integrated corrected rotation amount, and a determination unit configured to determine that the life of the bearing is exhausted when a predetermined value is exceeded by the integrated corrected rotation amount.

The temperature may vary as the rotational speed of the rotation axis supported by the bearing changes, and the degree of influence on the bearing life per revolution may vary depending on the temperature. In this case, however, the rotation amount is corrected to make the degree of influence on the bearing life per revolution uniform, so that the bearing life can be determined by the integrated value of the corrected rotation amount, that is, a total corrected rotation amount. Thus, the bearing can be maintained at a time close to its actual life limit.

Another bearing life determination device according to the present invention serves to determine the life of a bearing, which supports a rotation axis of a machine, and comprises storage unit stored with data for a coefficient corresponding to a rotational speed of the rotation axis or a calculation formula for calculating the coefficient from the rotational speed of the rotation axis, a rotational speed detecting unit configured to detect the rotational speeds of a plurality of rotation axes at a predetermined time interval, a rotation amount calculating unit configured to calculate rotation amounts of the rotation axes based on the detected rotational speeds and the time interval, a corrected rotation amount calculating unit configured to obtain the coefficient from the storage unit for each of the rotation axes, based on the rotational speeds detected by the rotational speed detecting unit, and a calculate corrected rotation amounts for life determination by multiplying the respective rotation amounts of the rotation axes calculated by the rotation amount calculating unit by the obtained coefficient, a corrected rotation amount integrating unit configured to integrate the calculated corrected rotation amounts for the individual rotation axes to obtain integrated corrected rotation amounts for the individual rotation axes, and a determination unit configured to determine that the life of the bearing for the rotation axis with the integrated corrected rotation amount exceeding a predetermined value is exhausted.

The temperature of the bearing may vary depending on the rotational speed of the rotation axis supported by the bearing, and the degree of influence on the bearing life per revolution may vary depending on the temperature. In this arrangement, however, an integrated corrected rotation amount is obtained by converting the rotation amount at each rotational speed for correction to an amount based on each unit revolution at a reference rotational speed, so that the bearing life can be determined by the integrated value of the corrected rotation amount, that is, a total corrected rotation amount. Thus, the bearing life can be determined by the rotation amount at the reference rotational speed, a uniform unit, in consideration of a temperature factor, so that the bearing can be maintained at a time close to its actual life limit.

The rotation axis may be driven by a speed-controlled motor, and the rotational speed detecting unit may detect a rotational speed of the motor, based on a command speed for the motor or a speed feedback signal, and detects the rotational speed of the rotation axis from the rotational speed of the motor. Thus, it is unnecessary to provide any special speed sensor.

Since the rotational speed is detected for the bearing of the machine with the speed-controlled motor, based on a signal related to the rotational speed generated in a control device for controlling the machine, any sensors for detecting the rotational speed of the rotation axis need not be newly provided. Thus, it is unnecessary to provide a space in which sensors are located, so that there are advantages in cost and space requirements.

The machine may be a machine tool such that the life of the bearing that supports the rotation axis, such as the spindle axis or feed axis of the machine tool, is determined.

### BRIEF DESCRIPTION OF THE DRAWINGS

The above and other objects and features of the present invention will be obvious from the ensuing description of embodiments with reference to the accompanying drawings, in which:

FIG. 1 is a schematic block diagram of a control device for a machine furnished with a bearing life determination device according to an embodiment of the present invention;

FIG. 2 shows examples of a coefficient set individually for a plurality of divided ranges of a spindle speed (number of revolutions) according to each embodiment of the invention;

FIG. 3 is an operation flow chart showing a first embodiment of the invention; and

FIG. 4 is an operation flow chart showing a second embodiment of the invention.

### DETAILED DESCRIPTION OF THE PREFERRED EMBODIMENTS

According to the present invention, the life of a bearing is determined by a rotation amount of a rotation axis supported by a bearing. The bearing life is determined by a total rotation amount or an integrated rotation amount of the rotation axis in consideration of the temperature that varies depending on the rotational speed of the rotation axis. Further, the bearing life of a machine can be determined using a signal generated in a control device of the machine without newly disposing sensors near the bearing.

### First Embodiment

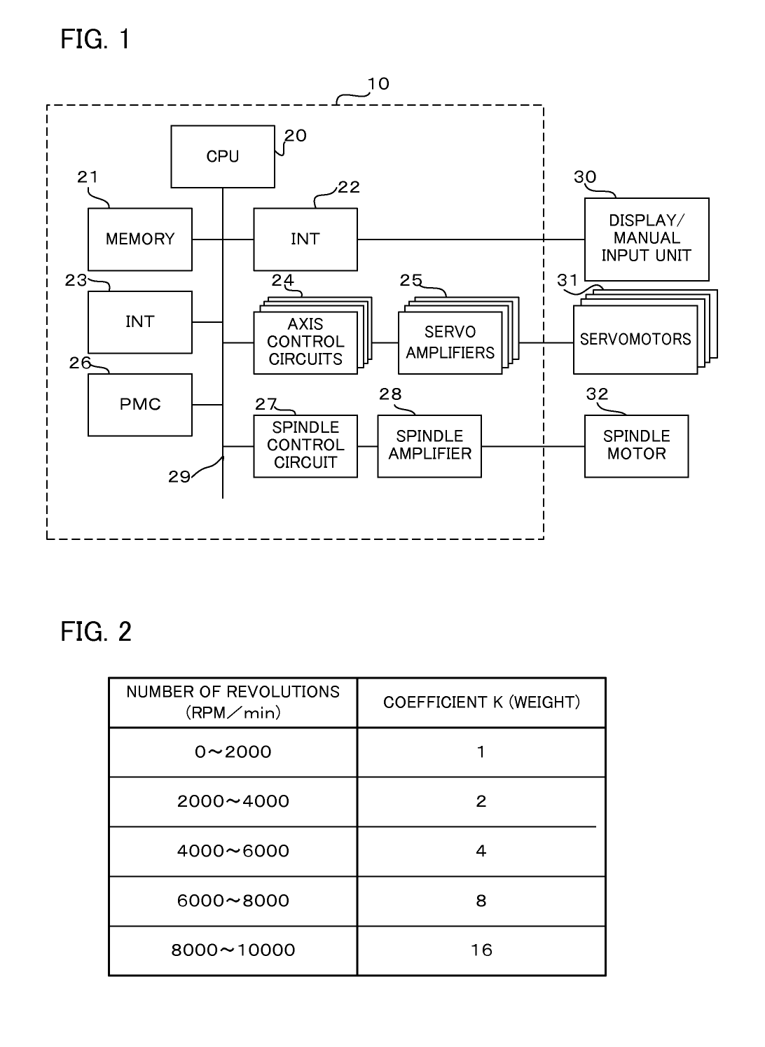

FIG. 1 is a schematic block diagram of a control device for a machine furnished with a bearing life determination device according to a first embodiment. In this first embodiment, the machine is a machine tool, and the control device for controlling the machine is a numerical control device. FIG. 1 is a schematic block diagram of the numerical control device 10. In the first embodiment, moreover, the life of the spindle of the machine tool, which is worked hard, is determined.

A CPU 20 is a processor for generally controlling the numerical control device 10 and is connected to a memory 21, interfaces 22 and 23, axis control circuits 24, programmable machine controller (PMC) 26, and spindle control circuit 27 by a bus 29.

The CPU 20 reads a system program stored in a ROM in the memory 21 through the bus 29 and controls the entire numerical control device 10 according to the read system program. The memory 21 comprises the ROM, a RAM, a nonvolatile memory, etc. The ROM is stored with the system program and the like, while the RAM is loaded with temporary calculation data, display data, and various data input through a display/manual input unit 30. Further, the nonvolatile memory is composed of an SRAM backed up by a battery. The nonvolatile memory is stored with set data to be retained even when the machine tool is switched off, such as various unit formed of software, a coefficient as a weight indicative of the degree of the influence of the number of revolutions or rotational speed of the spindle on the bearing life for each range, etc.

The interface 23 enables connection with external equipment. The PMC 26 is a sequential program stored in the numerical control device 10. The PMC 26 outputs a signal to an auxiliary device of the machine tool as an object to be controlled, thereby controlling the device, receives and processes signals from various switches on the machine tool body as required, and delivers them to the CPU 20.

Further, the interface 22 is connected with the display/manual input unit 30, which comprises a liquid-crystal or CRT display and a manual input unit such as a keyboard. On receiving move command amounts for the feed axes from the CPU 20, the axis control circuits 24 for controlling feed axes, such as X-, Y-, Z-axes, etc., output commands for the feed axes to their corresponding servo amplifiers 25, thereby driving servomotors 31 for the feed axes. On receiving position/speed feedback signals from position/speed sensors individually built in the servomotors 31, moreover, the axis control circuits 24 performs position/speed feedback control such that the rotational speed of each servomotor is equal to a command speed.

On receiving a spindle speed command from the CPU 20, the spindle control circuit 27 outputs a spindle speed signal to a spindle amplifier 28. On receiving the spindle speed signal, the spindle amplifier 28 rotates a spindle motor 32 at a commanded rotational speed or number of revolutions. On receiving feedback pulses fed back in synchronism with the rotation of a position coder (not shown), the spindle amplifier 28 performs feedback control of the rotational speed of the spindle such that the spindle speed agrees with the spindle speed command.

As described above, the hardware configuration of the numerical control device 10 for use as a machine controller is the same as that of a conventional numerical control device. However, the numerical control device 10 differs from the conventional one in that software used in the bearing life determination device is stored in the memory 21, e.g., the ROM or a nonvolatile memory, and that a coefficient K for each divided range of the spindle speed, such as that shown in FIG. 2, and a life limit value TLim of the bearing are set and stored in the memory 21.

FIG. 2 shows set examples of the coefficient K indicative of the weight that influences the bearing life for each of a plurality of divided ranges of the spindle or spindle motor speed stored in the memory 21. In the examples shown in FIG. 2, five ranges are given, including 0 to 1,999 rpm, 2,000 to 3,999 rpm, 4,000 to 5,999 rpm, 6,000 to 7,999 rpm, and 8,000 to 10,000 rpm. The coefficient K may be calculated according to a preset calculation formula derived from the rotational speed, that is, obtained by approximating a curve indicative of the coefficient value to the rotational speed, instead of being numerically set for each speed range.

The life of the bearing varies depending on the temperature and is shorter at higher temperatures than at lower temperatures. The bearing becomes hotter when the rotation axis rotates rapidly than when the axis rotates slowly. Therefore, the bearing life is more influenced by high-speed rotation than by low-speed rotation. According to the first embodiment, the coefficient K is set with the degree of the influence of rotation on the bearing life regarded as the weight per revolution. Thus, the coefficient K is set as the ratio of the degree of the influence of a certain rotational speed (rpm) on the bearing life to that of a reference rotational speed. Since higher-speed rotation influences the life more than lower-speed rotation does, the value of the coefficient K as the weight is greater during the higher-speed rotation. As described later, a corrected rotation amount for life determination is obtained by multiplying a rotation amount by this coefficient. For example, each revolution of high-speed rotation at 8,000 to 10,000 rpm has an influence on the bearing life 16 times greater than that of each revolution of low-speed rotation at 0 to 1,999 rpm. Therefore, the coefficient K is set to 16, based on the assumption that each revolution of high-speed rotation at 8,000 to 10,000 rpm is 16 times more influential on the bearing life than each revolution at the reference rotational speed. In the high-speed rotation at 8,000 to 10,000 rpm, each revolution has an influence on the bearing life 16 times greater than that of each revolution at the reference rotational speed. Therefore, the corrected rotation amount is obtained by multiplying the high-speed rotation amount by the coefficient K of 16 and correcting it to an amount at the reference rotational speed for the same degree of influence on the bearing life. Thus, the rotation amount is converted to each unit revolution at the reference rotational speed for the same degree of influence on the bearing life without regard to the rotational speed. This coefficient K is obtained and set by an experiment or the like.

According to the first embodiment, the life of the bearing that supports the spindle of the coefficient K is determined. Since the rotational speed of the spindle is equal to that of the spindle motor for driving the spindle, it can be detected by detecting a command speed for the spindle motor without an additional speed sensor. If the spindle and the spindle motor are different in rotational speed, the difference can be compensated for by adjusting the value of the coefficient K.

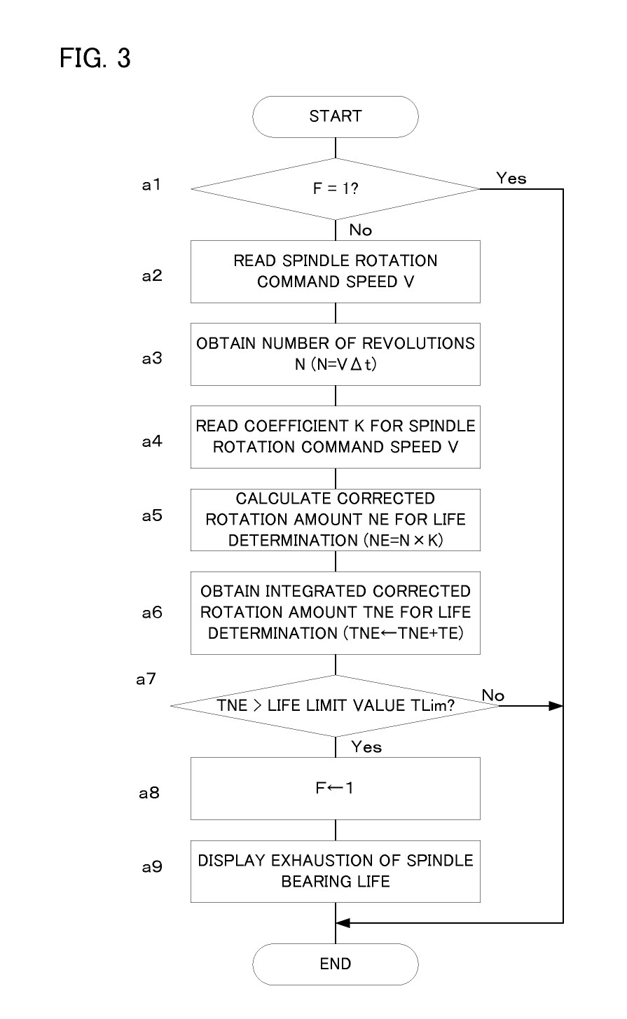

FIG. 3 is an operation flow chart of software used in the bearing life determination device of the first embodiment stored in the memory 21.

The CPU 20 performs the processing shown in FIG. 3 for each predetermined time interval (hereinafter referred to as the predetermined period) Δt when a drive command for the machine tool is input.

First, it is determined whether or not a flag F is set to see if the life limit of the spindle bearing is exceeded (Step a1). If the flag F is not set (F≠1), a spindle rotation command speed V then output to the spindle control circuit 27 is read (Step a2), and the read rotation command speed V is multiplied by a period time Δt for the execution of the processing shown in FIG. 3 to obtain a number of spindle revolutions N within this period time (Step a3). Then, the value of the coefficient K for the divided range including the spindle rotation command speed V read in Step a2 is read from data for the values of the coefficient K set for the individual divided ranges of the spindle speed shown in FIG. 2, which are previously set and stored (Step a4). A corrected rotation amount NE for life determination, corrected to each unit revolution at the reference rotational speed, is obtained by multiplying the number of spindle revolutions N obtained in Step a3 by the read value of the coefficient K (Step a5). The corrected rotation amount NE is a value obtained by correcting the rotation amount so that the degree of influence of each revolution on the bearing life, along with that of temperature, is constant. During the high-speed rotation at 8,000 to 10,000 rpm, in the example shown in FIG. 2, the corrected rotation amount is obtained by multiplying a rotation amount N by the coefficient K of 16 and converting it to a corresponding amount in unit of revolution at the reference rotational speed (at 0 to 2,000 rpm with the coefficient K=1) with the same amount of influence on the bearing life. Thus, the rotation amount is corrected to a corresponding amount in unit of revolution at the reference rotational speed, despite the change of the rotational speed, so that the bearing life can be determined by an integrated value of the converted corrected rotation amount in the unit.

Then, the corrected rotation amount NE obtained in Step a5 is added to an integrated corrected rotation amount THE for life determination stored in the nonvolatile memory 21, whereby an updated new integrated corrected rotation amount TNE for the period concerned is obtained and stored in the memory 21 (Step a6). This integrated corrected rotation amount can be represented by a value in unit of revolution at the reference rotational speed.

The integrated corrected rotation amount TNE is the up-to-date sum of revolutions at the reference rotational speed. It is determined whether or not the preset life limit value TLim is exceeded by the integrated corrected rotation amount TNE (Step a7). If the life limit value TLim is not exceeded, the processing in the period concerned ends. If the value TLim is exceeded, in contrast, the flag F is set to “1” (Step a8), and an indication to the effect that the life of the spindle bearing is exhausted is displayed by the display/manual input unit 30 (Step a9). The life limit value TLim is set in such a manner that the rotation amount with which the life limit of the bearing reached is obtained in unit of revolution at the reference rotational speed, with the rotational speed in the range of 0 to 1,999 rpm with the coefficient K of 1.

As described above, the processing of Steps a1 to a7 is executed for each period before the preset life limit value TLim is exceeded by the integrated corrected rotation amount THE of the spindle. After the life limit value TLim is exceeded by the integrated corrected rotation amount THE and the flag F is set to “1” (Steps a8 and a9) so that the attainment of the life limit by the bearing that supports the spindle is displayed, this display remains unchanged.

When the bearing and the like are replaced after maintenance, the integrated corrected rotation amount THE stored in the memory 21 is reset to “0”, and the flag F is also reset to establish an initial state. If the operation of the machine tool is resumed thereafter, the processing of Steps a1 to a9 is executed for each period, and the operation for determining the spindle bearing life is performed again.

In the first embodiment, as shown in FIG. 2, the coefficient K is set for each rotational speed range. Alternatively, however, the value of the coefficient K may be obtained as a function of the rotational speed based on a calculation formula derived from the rotational speed. For example, an approximation for the relationship between the rotational speed and the coefficient K may be previously registered, as shown in FIG. 2, so that the coefficient K can be obtained from a rotational speed detected according to the approximation.

In the first embodiment, the rotation amount is corrected based on the rotational speed of the rotation axis, and the bearing life is determined by the integrated value of the corrected rotation amount, that is, a total corrected rotation amount. Thus, the bearing life is determined in consideration of a temperature factor that influences the bearing life. In this way, the bearing life can be accurately determined at a time closer to the actual life limit of the bearing. Since the spindle bearing of the machine tool is worked harder than a feed shaft bearing, moreover, the life of only the spindle bearing is determined according to the first embodiment. However, the present invention is also applicable to a bearing for another feed shaft. Further, the life of a bearing that supports a rotation axis of a machine other than the machine tool may be determined in the same manner as in the first embodiment.

### Second Embodiment

According to a second embodiment, the life performance of all bearings or a plurality of selected bearings in a machine is determined. Also in this second embodiment, the machine is a machine tool, and its control device is a numerical control device, such as that shown in FIG. 1. The machine tool has four rotation axes, including a spindle axis and feed axes, that is, X-, Y-, and Z-axes. The spindle axis is driven by a spindle motor 32, which is driven by a spindle control circuit 27 and a spindle amplifier 28. Further, the feed axes or the X-, Y-, and Z-axes are driven by servomotors 31 that are driven by their corresponding axis control circuits 24 and servo amplifiers.

On receiving a spindle rotation command speed from a CPU 20, as described above in connection with the first embodiment, the spindle control circuit 27 feedback-controls the speed of the spindle motor 32 to be equal to the command speed. On receiving speed commands from the CPU 20, moreover, the axis control circuits 24 for the X-, Y-, and Z-axes perform speed feedback control to meet the commands. Thus, the servomotors 31 are driven by the servo amplifiers to control their corresponding rotation axes.

In the second embodiment, the bearings for four rotation axes, that is, the spindle axis and the X-, Y-, and Z-axes, are assumed to be selected for the life determination.

As in the first embodiment, a coefficient K representative of a weight that influences the life of the bearings is set in a memory 21 for each of a plurality of divided ranges of the rotational speed or number of revolutions of each rotation axis, such as those shown in FIG. 2. Alternatively, as in the first embodiment, moreover, the value of the coefficient K may be obtained based on a previously set calculation formula derived from the rotational speed. Further, the X-, Y-, and Z-axes are feedback-controlled to agree with command speeds for the motors for them. Thus, the rotational speed of each feed axis or rotation axis can be detected by detecting the command speed for each axis motor. As in the first embodiment, furthermore, the rotational speed of the spindle is detected by detecting the command speed for the spindle motor.

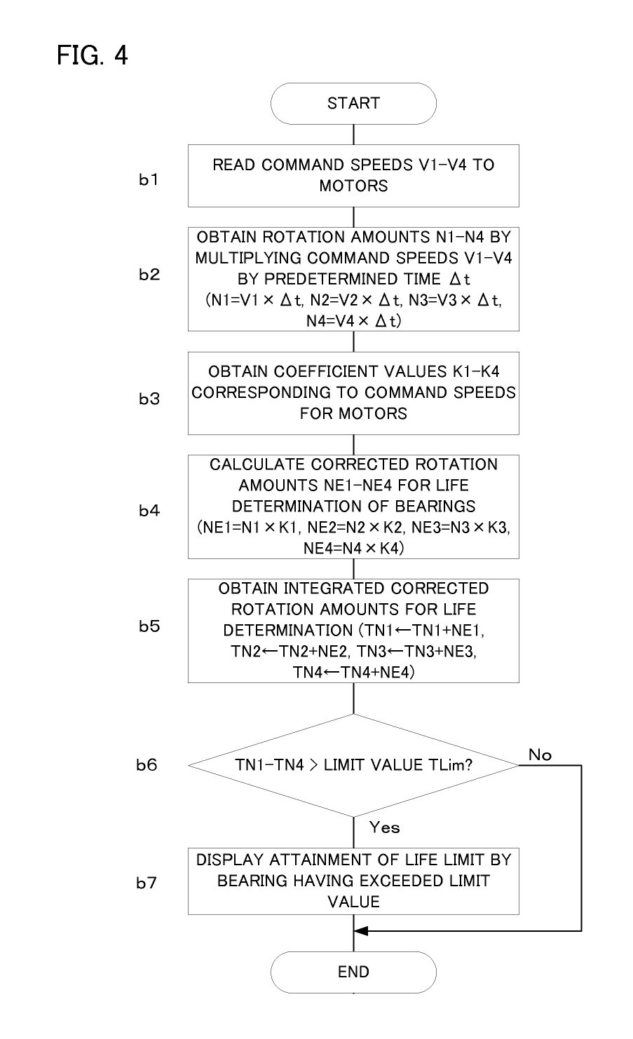

FIG. 4 is an operation flow chart of software used in the bearing life determination device of the second embodiment stored in the memory 21.

The CPU 20 performs the processing shown in FIG. 4 for each predetermined time interval or predetermined period Δt when an operation command for the machine tool is input.

First, command speeds V1 to V4 output from the CPU 20 to the spindle control circuit 27 and the axis control circuits 24 are read (Step b1), and rotation amounts N1 to N4 for the predetermined period Δt are obtained by multiplying the command speeds V1 to V4 by the predetermined period Δt (Step b2). These obtained amounts, as shown below, are the rotation amounts of the motors and of the rotation axes driven by the motors.

N1=V1×Δt, N2=V2×Δt, N3=V3×Δt, and N4=V4×Δt

Then, coefficient values K1 to K4 for the ranges including the command speeds or command numbers of revolutions for the motors or the rotation axes are obtained for the individual rotation axes, based on registered data for the values of the coefficient K (Step b3).

Corrected rotation amounts NE1 to NE4 for life determination are obtained by multiplying the rotation amounts N1 to N4 of the rotation axes or the motors obtained in Step b2 by the coefficient values K1 to K4 for the rotation axes, respectively, as below (Step b4).

NE1=N1×K1, NE2=N2×K2, NE3=N3×K3, and NE4=N4×K4

The obtained corrected rotation amounts NE1 to NE4 for the period concerned are added to integrated corrected rotation amounts TN1 to TN4 for life determination of the rotation axes or bearings stored in the nonvolatile memory 21, whereby the integrated corrected rotation amounts TN1 to TN4 are updated, as below (Step b5).

TN1←TN1+NE1, TN2←TN2+NE2, TN3←TN3+NE3, and TN4←TN4+NE4

Then, it is determined whether or not a preset life limit value TLim is exceeded by the integrated corrected rotation amounts TN1 to TN4 obtained for the individual rotation axes in Step b5, that is, by the up-to-date total rotation amount converted to an amount based on each unit revolution at the reference rotational speed (Step b6).

If there is no bearing having exceeded the life limit value TLim, the processing of the period concerned ends. If there is any rotation axis having exceeded the life limit value TLim, an indication to the effect that the life limit is reached by the bearing that supports the rotation axis concerned is displayed on a display/manual input unit (Step b7).

The above-described processing of Steps b1 to b7 is executed for each predetermined period.

When the bearing shown to have reached its life limit is replaced with a new one in maintenance work, the integrated corrected rotation amounts TN for the rotation axes or bearings stored in the memory 21 are reset to “0”.

In this second embodiment, the life limit value TLim is used in common for all the bearings that are regarded as being of the same type and quality. If the bearings are different in type or quality, the life limit value TLim is set for each bearing axis so that it can be compared with that set for the axis concerned in Step b6. If the bearings vary in temperature-life characteristics, moreover, the coefficient K should only be set for each bearing.

According to the first and second embodiments described above, the rotational speed of each rotation axis is detected based on the command speed for the motor that drives the rotation axis. Since the motor speed is fed back, however, the rotational speed of each rotation axis may alternatively be detected by detecting the motor speed by the speed feedback signal. Thus, the rotational speed of each motor or rotation axis may be detected based on the mounting positions on the servomotors 31, feedback signals from the speed sensors, and a feedback signal from the position coder on the spindle motor. If the rotational speed of each motor is different from that of its corresponding rotation axis, moreover, the value of the coefficient K of the rotation axis or bearing to be used should also be set in consideration of conversion from the motor speed to the rotation axis speed.

While the present invention is applied to the machine tool according to the embodiments described above, it is also applicable to a machine other than the machine tool, e.g., a robot for which the motor speed is configured to be controlled.

If the rotational speed of a rotation axis driven by a motor without speed control is unknown, furthermore, it should only be detected using a sensor for axis speed detection.

1. A bearing life determination device for determining the life of a bearing which supports a rotation axis of a machine, the bearing life determination device comprising:
a storage unit stored with data for a coefficient corresponding to a rotational speed of the rotation axis or a calculation formula for calculating the coefficient from the rotational speed of the rotation axis;
a rotational speed detecting unit configured to detect the rotational speed of the rotation axis at a predetermined time interval;
a rotation amount calculating unit configured to calculate a rotation amount of the rotation axis based on the detected rotational speed and the time interval;
a corrected rotation amount calculating unit configured to obtain the coefficient corresponding to the rotational speed of the rotation axis detected by the rotational speed detecting unit, based on the data or the calculation formula stored in the storage unit and calculate a corrected rotation amount for life determination by multiplying the rotation amount calculated by the rotation amount calculating unit by the obtained coefficient;
a corrected rotation amount integrating unit configured to integrate the calculated corrected rotation amount to obtain an integrated corrected rotation amount; and
a determination unit configured to determine that the life of the bearing is exhausted when a predetermined value is exceeded by the integrated corrected rotation amount.

2. A bearing life determination device for determining the life of a bearing which supports a rotation axis of a machine, the bearing life determination device comprising:
a storage unit stored with data for a coefficient corresponding to a rotational speed of the rotation axis or a calculation formula for calculating the coefficient from the rotational speed of the rotation axis;
a rotational speed detecting unit configured to detect the rotational speeds of a plurality of rotation axes at a predetermined time interval;
rotation amount calculating unit configured to calculate rotation amounts of the rotation axes based on the detected rotational speeds and the time interval;
a corrected rotation amount calculating unit configured to obtain the coefficient from the storage unit for each of the rotation axes, based on the rotational speeds detected by the rotational speed detecting unit, and calculate corrected rotation amounts for life determination by multiplying the respective rotation amounts of the rotation axes calculated by the rotation amount calculating unit by the obtained coefficient;
a corrected rotation amount integrating unit configured to integrate the calculated corrected rotation amounts for the individual rotation axes to obtain integrated corrected rotation amounts for the individual rotation axes; and
a determination unit configured to determine that the life of the bearing for the rotation axis with the integrated corrected rotation amount exceeding a predetermined value is exhausted.

3. The bearing life determination device according to claim 1, wherein the rotation axis is driven by a speed-controlled motor, and the rotational speed detecting unit detects a rotational speed of the motor, based on a command speed for the motor or a speed feedback signal, and detects the rotational speed of the rotation axis from the rotational speed of the motor.

4. The bearing life determination device according to claim 3, wherein the machine is a machine tool.
